(19) United States
(12) Patent Application Publication
(10) Pub. No.: US 2007/0174248 A1
(43) Pub. Date: Jul. 26, 2007

(54) Method and system for data processing with load balance

(76) Inventors: Shota Kumugai, Yokohama (JP); Nobuo Kawamura, Atsugi (JP); Norihiro Hara, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/365,496

(22) Filed: Mar. 2, 2006

(30) Foreign Application Priority Data
Jan. 24, 2006 (JP) 2006-014623

(51) Int. Cl. G06F 17/30

(52) U.S. Cl. 707/3

(57) ABSTRACT

In a database management method, a plurality of nodes are instructed to execute queries to the data base stored in a storage. A computer receives the input of the queries, and divides each input query into a plurality of processing phases constituting units capable of being executed in parallel. Based on the feature of the processing phases and the operating condition of each node at the time of execution of the processing phases of each query, the processing phases of the query are distributed among the nodes. The predetermined intended application of each node and the application of each query specified by the type of the query are compared with each other thereby to specify the nodes to which the processing phases are distributed.

### INCORPORATION BY REFERENCE

The present application claims priority from Japanese application JP2006-014623 filed on Jan. 24, 2006, the content of which is hereby incorporated by reference into this application.

### BACKGROUND OF THE INVENTION

This invention relates to a database management method, a database management program, a database management apparatus and a database management system.

The database management system (DBMS) is for responding to a query to a data base. Especially, the relational database management system (RDBMS) with a data base in table form is widely used. A language often used to describe the query about the data is SQL (structured query language).

In order to respond to many queries, the query processing time is required to be shortened. Conventionally, queries are processed in a plurality of phases each distributed among a plurality of nodes (computer resources) for parallel pipeline processing.

The distribution algorithm for determining the nodes to which the processing phase is distributed is crucial. Joel L. Wolf, John Turek, Ming-Syan Chen and Philip S. Yu: “A Hierarchical Approach to Parallel Multiquery Scheduling”, IEEE Transactions on Parallel and Distributed Systems, 6(6): 578-590, Jun. 1995, for example describes the distribution of each processing phase based on the various statistical information on the queries to be processed and held in the DBMS dictionary.

### SUMMARY OF THE INVENTION

In the conventional distribution algorithm, however, the processing efficiency cannot be sufficiently improved. The current processing load of each load is not taken into consideration by the mere distribution of the query process among a plurality of nodes considering the load to process the query processing phase. The current processing load is generated by other transactions being processed by the nodes.

As the result of distributing the processing phases without considering the current processing load of the nodes, the simultaneous distribution of the processing phases of the same processing load among different nodes leads to variations in the ending time of the processing phases due to the effect of the current processing load on the processing of the processing phases. In spite of the presence of some nodes having a margin of resources, therefore, the processing of different queries is distributed to the same node, with the result that a plurality of nodes included in a system cannot be utilized with equal load.

In view of this, the primary object of the invention is to solve this problem and efficiently distribute the data base query process.

In order to solve the aforementioned problem, according to this invention, there is provided a database management method for instructing a plurality of nodes to process the queries to the database stored in a storage, wherein a computer executes the query request step for receiving the input of queries, the query analysis step for dividing the input queries into processing phases as units capable of being executed in parallel, and the process distribution step for distributing the processing phases of the queries among the nodes based on the features of the processing phases and the operating conditions of each node at the execution time of the processing phases. The other means included are described later.

According to this invention, the phases are distributed taking the operating conditions between the nodes into consideration, and therefore the unbalanced state of the operating conditions between the nodes is eliminated. Thus, the processing of the queries to the data base can be efficiently distributed and the queries can be processed by the DBMS at higher speed.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a general configuration of a database management system according to a first embodiment of the invention.

FIG. 2 is a diagram showing a configuration of a database management system according to the first embodiment of the invention.

FIG. 3 is a diagram for explaining the operating conditions and the primary application of the nodes according to the first embodiment of the invention.

FIG. 4 is a diagram for explaining the intended node application and the queries to be processed according to the first embodiment of the invention.

FIG. 5 is a diagram for explaining the features of queries and applications according to the first embodiment of the invention.

FIG. 6 is a flowchart showing the process of registering the intended node application according to the first embodiment of the invention.

FIG. 7 is a flowchart showing the process of acquiring the node information according to the first embodiment of the invention.

FIG. 8 is a flowchart showing the process distribution operation according to the first embodiment of the invention.

FIG. 9 is a diagram showing a configuration of a database management system according to the first embodiment of the invention.

FIG. 10 is a diagram showing a configuration of a database management system according to a second embodiment of the invention.

FIG. 11 is a diagram showing a configuration of a database management system according to a third embodiment of the invention.

FIG. 12 is a diagram showing a configuration of a database management system according to a fourth embodiment of the invention.

FIG. 13 is a diagram showing a node information management table according to an embodiment of the invention.

FIG. 14 is a diagram showing a node information management table according to an embodiment of the invention.

FIG. 15 is a diagram showing a node information management table according to an embodiment of the invention.

FIG. 16 is a diagram showing a node information management table according to an embodiment of the invention.

FIG. 17 is a diagram showing a hardware configuration of a database management system according to an embodiment of the invention.

FIG. 18 is a diagram showing a hardware configuration of a database management system according to an embodiment of the invention.

### DESCRIPTION OF THE EMBODIMENTS

The preferred embodiments of the invention are described below with reference to the drawings. First, a first embodiment of the invention is described.

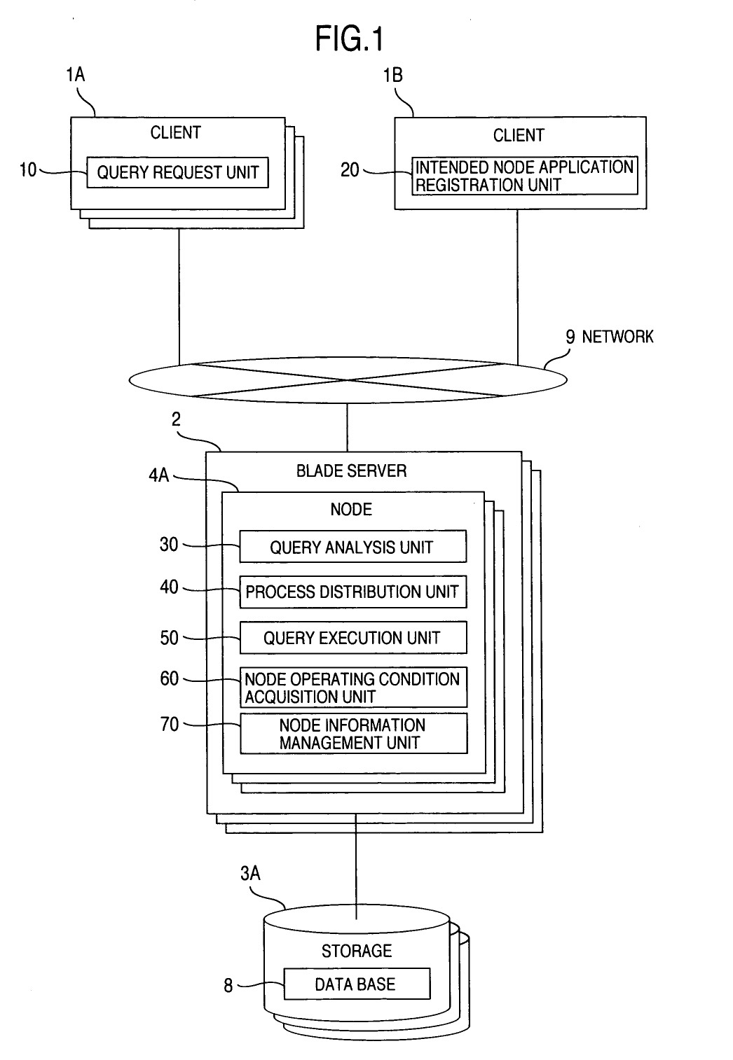

FIG. 1 shows a configuration of a DBMS according to the first embodiment. This embodiment is implemented by one or more clients including a client 1A and a client 1B connected by a network 9, at least one blade server 2 and a storage 3A connected with the blade server 2. The storage 3A has a data base 8.

The client 1A has a query request unit 10, and the client 1B an intended node application registration unit 20. The blade server 2 accommodates at least one node 4A. The node 4A is configured removably from the blade server 2 and can be added as required. With the recent advent of the blade server 2, the hardware node configuration change has been facilitated, and the software technique that can effectively utilize the nodes included in the system at the time of adding or removing a blade is closely watched.

The means in which the node 4A is accommodated is not limited to the blade server 2. The node 4A may be accommodated, for example, on a rack. Also, the node 4A may be a physical computer or a virtual computer. In the case where the node 4A is a virtual computer, a physical computer is used to implement the virtual computer in place of the blade server 2.

The node 4A includes a query analysis unit 30, a process distribution unit 40, a query execution unit 50, a node information management unit 70 and a node operating condition acquisition unit 60.

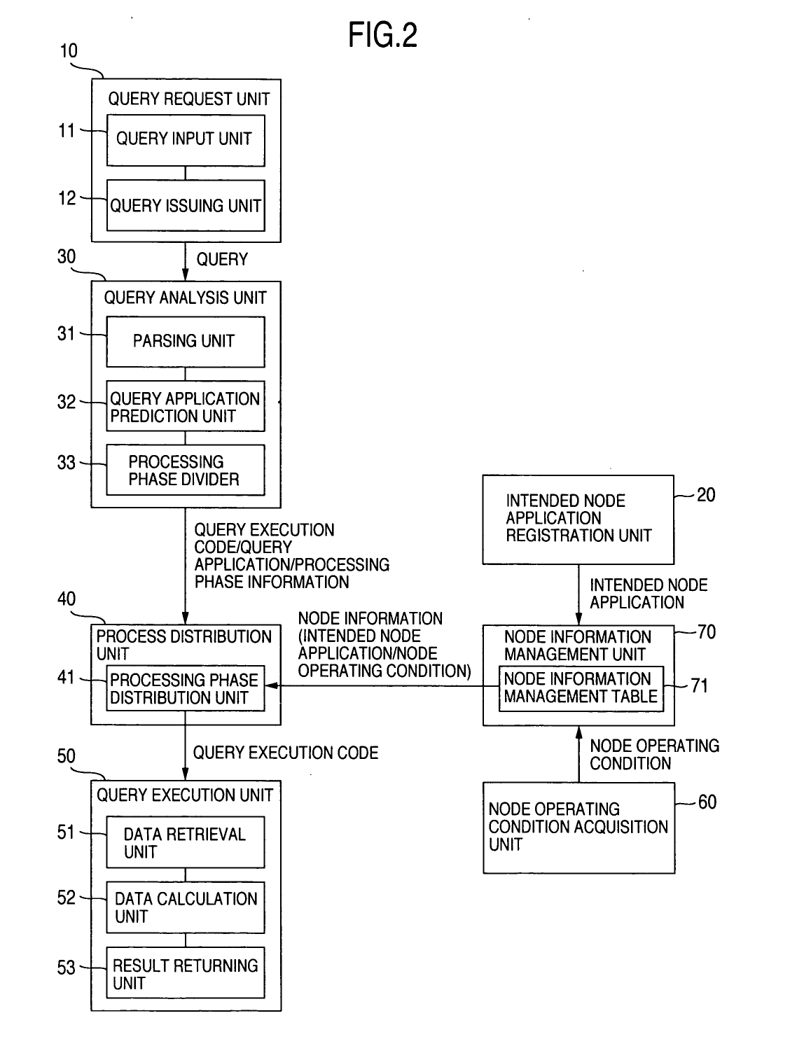

FIG. 2 shows, in more detail, each element of the configuration shown in FIG. 1.

The intended node application registration unit 20 provides an interface in which the user's intended application of the node included in the system can be registered, and outputs the registered intended node application to the node information management unit 70. The node operating condition acquisition unit 60 makes a query to each node at the request of the node information management unit 70 thereby to acquire the operating condition of each node, and outputs the node operating condition to the node information management unit 70. The node information management unit 70 manages, in a node information management table 71, the intended node application input from the intended node application registration unit 20 and the node operating condition input from the node operating condition acquisition unit 60.

The query request unit 10 includes a query input unit 11 and a query issuing unit 12. The query input unit 11 is supplied with a query from the user. The query issuing unit 12 notifies the input query to the query analysis unit 30.

The query analysis unit 30 includes a parsing unit 31, a query application prediction unit 32 and a processing phase divider 33. The parsing unit 31 parses the query issued from the query request unit 10. The parsing is the syntactic analysis of SQL. The query application prediction unit 32 predicts the application of the query. The processing phase divider 33 divides the query process into a plurality of processing phases for parallel processing with a plurality of nodes.

The process distribution unit 40 has a processing phase distribution unit 41. The processing phase distribution unit 41 distributes the processing phases divided by the query analysis unit 30 among the nodes based on the features of each processing phase (the additional processing information, etc.) and the node information acquired from the node information management unit 70, and outputs a query execution code to the query execution unit 50 of the distributed node.

The query execution unit 50 includes a data retrieval unit 51, a data calculation unit 52 and a result returning unit 53. The data retrieval unit 51 retrieves the data from the data base 8. The data calculation unit 52 makes the calculations as designated by the query to execute the distributed query execution code. The result returning unit 3 returns the calculation result to the client.

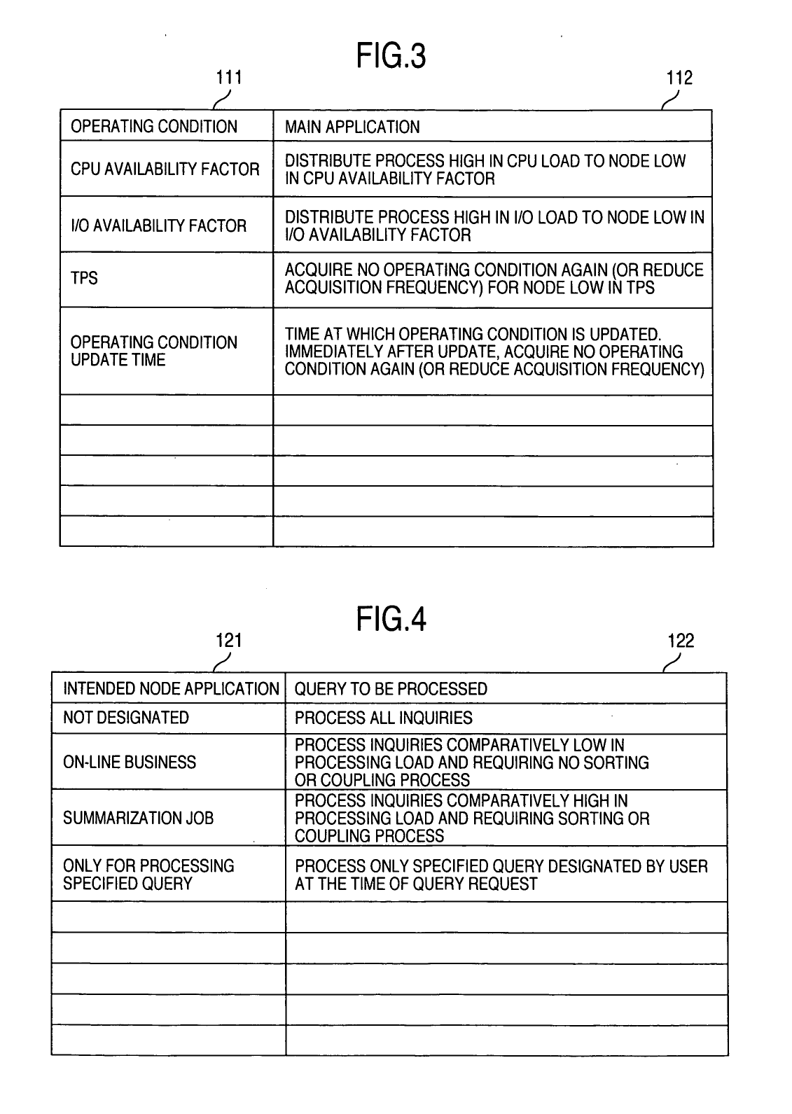

FIG. 3 shows the information held in the node information management table 71. The node information management table 71 holds the operating condition 111 and the intended node application 121 for all the nodes existing in the system. The operating condition 111 is used by the process distribution unit 40 to distribute the phases of the query process among the nodes in accordance with the main application 112. In the case where the operating condition 111 is “TPS (transactions per second (the number of transactions that can be processed per second (unit time))” and the main application 112 is “the operating condition is not acquired again for the node low in TPS”, for example, it indicates that the process distribution unit 40 accesses the parameter TPS and determines that the operating condition is not acquired again for the node low in TPS.

FIG. 4 shows the information held in the node information management table 71. The intended node application 121 is used by the process distribution unit 40 to distribute the phases of the query process among the nodes in accordance with the query 122 to be processed. In the case where the intended node application 121 is set as “the on-line business”, for example, the query 122 to be processed is “the query comparatively low in processing load and requiring no sorting process or coupling process”.

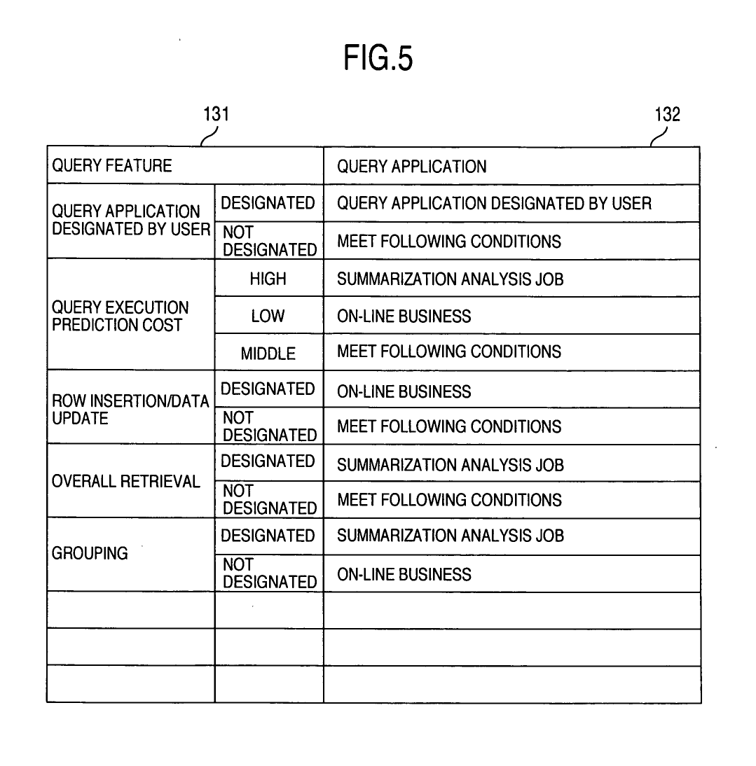

FIG. 5 shows the conditions to be met for the query application prediction by the query application prediction unit 32. The query application prediction unit 32 is supplied with the query analysis result from the parsing unit 31 and outputs the query application 132 in accordance with the query feature 131. In the case where the query feature 131 is “the query execution prediction cost is low”, for example, the query application is “the on-line business”, and the particular query is assigned to the node in which the same “on-line business” is set as the intended node application 121.

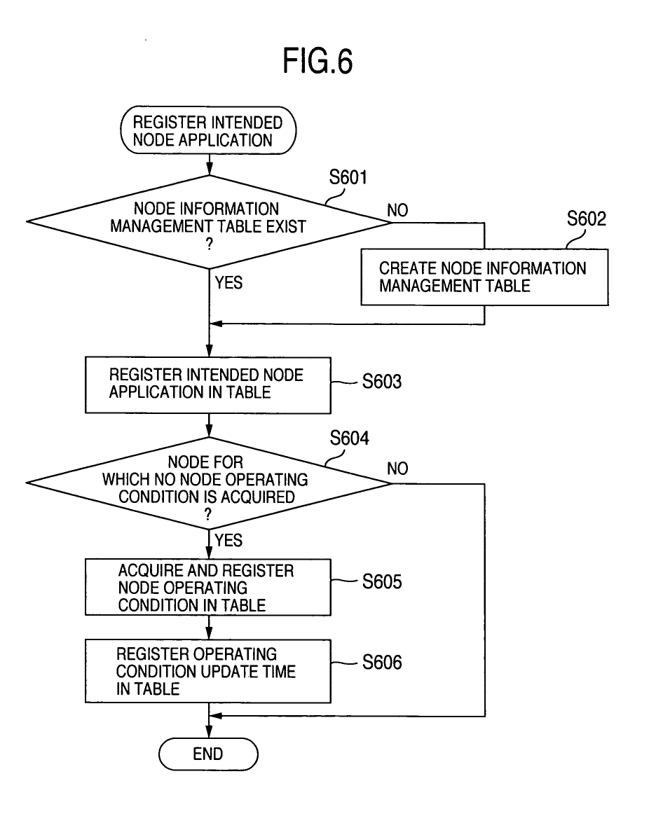

FIG. 6 shows the flow of the intended node application registration in the node information management unit 70. The node information management unit 70 determines whether the node information management table is available or not (S601), and unless the node information management table exits (NO at S601), the node information management table is created (S602).

Next, the node information management unit 70 registers the intended node application in the node information management table (S603). The node information management unit 70 then determines whether the node operating condition is acquired for the node of which the intended application is registered (S604), and in the case where the operating condition is not acquired for the node (YES at S604), the node operating condition is acquired and registered in the node information management table (S605) and so is the operating condition update time (S606). In the case where the operating condition is acquired for the node (NO at S604), on the other hand, the process is ended.

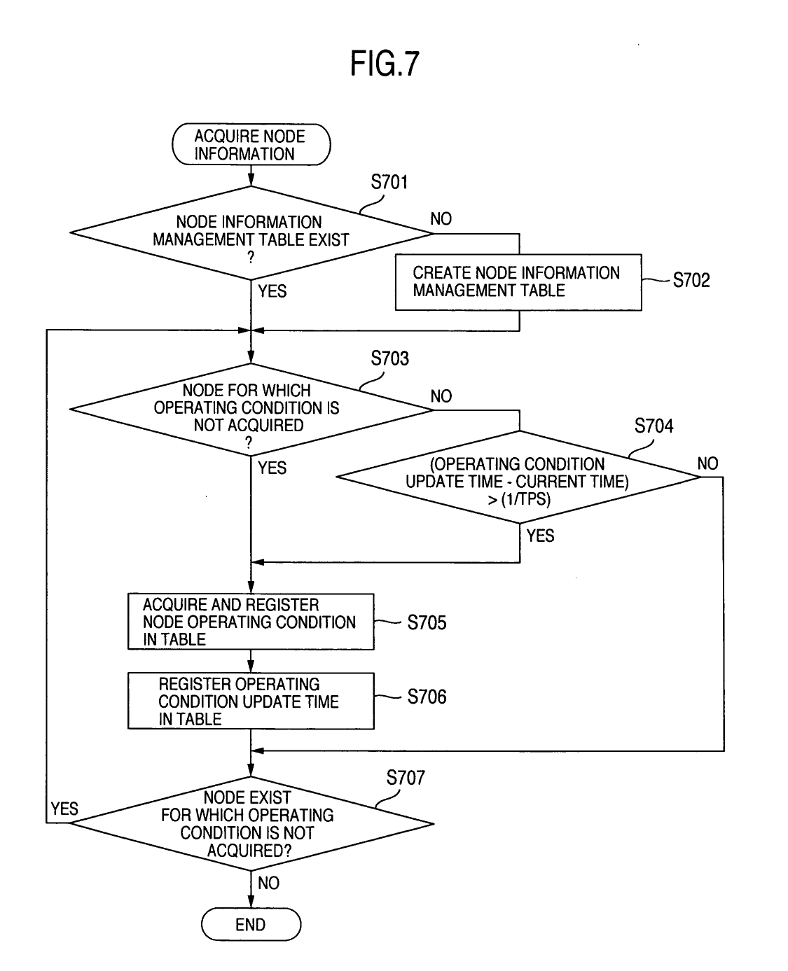

FIG. 7 shows the flow of node information acquisition in the node information management unit 70. The node information management unit 70 determines whether the node information management table exists or not (S701), and in the absence of the node information management table, creates the one (S702).

Next, the node information management unit 70 determines whether the operating condition of a particular node is acquired or not (S703), and unless the node operating condition for the node is acquired (YES at S703), the node operating condition is acquired and registered in the node information management table (S705) and so is the operating condition update time (S706). Due to this registration at S706, the overhead of the inter-node communication to acquire the node operating condition can be reduced in the presence of information for which the determination at S704 is NO.

The node information management unit 70, also with regard to other than the node for which the operating condition that is not acquired (NO at S703), i.e. the node for which the operating condition is acquired, determines whether the information is new and indicates the current condition or not, from the equation (operating condition update time—current time)>(1/TPS) based on the difference between the operating condition update time and the current time (S704).

In the case where this equation is satisfied (YES at S704), the acquired information on the operating condition is obsolescent, and the reacquisition is determined as necessary. The node information management unit 70 repeats this process until there no longer exists the node for which the operating condition is not acquired (S707).

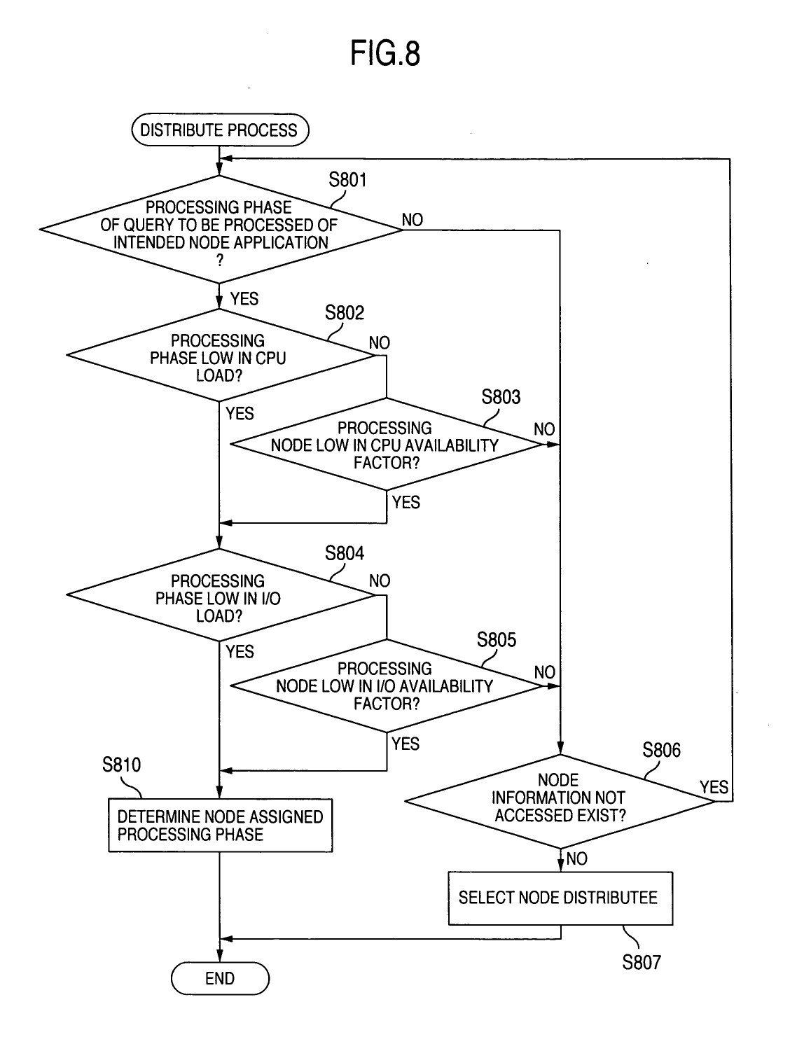

FIG. 8 shows the process executed by the processing phase distribution unit 41 to distribute the processing phases of the query among the nodes. The processing phase distribution unit 41, by accessing the node information input from the node information management unit 70 for each node, determines whether the processing phase of the query is the one to be processed for the intended application or not (S801).

In the case where the processing phase of the query is the one to be processed (YES at S801), the processing phase distribution unit 41 determines whether the processing phase is low in CPU load or not, based on the result of the query analysis by the query analysis unit 30 (S802). In the case where the processing phase is not low in CPU load (NO at S802), the processing phase distribution unit 41 determines whether the node accessing the node information is low in CPU availability factor (S803).

In the case where the processing phase is low in CPU load (YES at S802) or the node accessing the node information is low in CPU availability factor (YES at S803), the processing phase distribution unit 41 determines whether the processing phase is low in I/O load or not (S804).

In the case where the processing phase is not low in I/O load (NO at S804), the processing phase distribution unit 41 determines whether the node accessing the node information is low in I/O availability factor or not (S805). In the case where the processing phase is low in I/O load (YES at S804) or in the case where the node accessing the node information is low in I/O availability factor (YES at S805), the processing phase distribution unit 41 determines the node accessing the node information as that of the assignee of the processing phase (S810).

With regard to a processing phase of the query not to be processed for an intended application (NO at S801), a node not low in CPU availability factor (NO at S803) or a node not low in I/O availability factor (NO at S805), the processing phase distribution unit 41 determines whether there exists the node information not accessed (S806). In the case where there exists the node information not accessed (YES at S806), the processing phase distribution unit 41 repeats the process from S801. In the absence of the node information not accessed, on the other hand, the node to which the processing phase is distributed is selected by the well-known technique (S807). In the well-known technique, for example, the node to which the processing phase is distributed is selected at random without taking the node operating condition into consideration. The random distribution is expected to disperse the load.

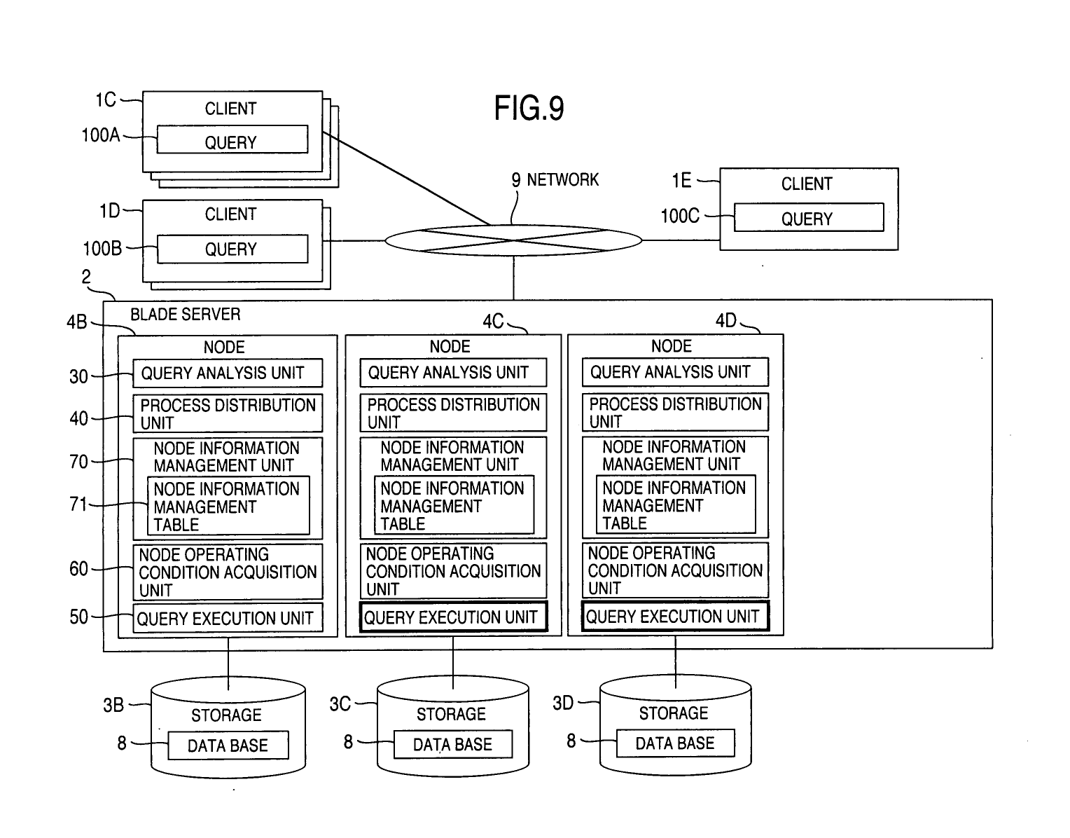

FIG. 9 shows a system configuration using RDBMS of the shared nothing architecture. The DBMS operates on three blades (nodes 4B, 4C, 4D) inserted in the blade server 2.

The client 1C makes a query to the DBMS through the network 9 in the same time zone. The operation is explained in which a great amount of the queries 100A from the client C1 are processed by the query execution unit 50 of the node 4B, the queries 100B from a plurality of clients 1D are received by the node 4C and the query 100C from the client 1E is received by the node 4B in the time zone of execution by the query execution unit 50 of the node 4C.

An example of the query 100A and the query 100B is shown below.

INSERT INTO T1 (C1, C2) VALUES (‘AAA’, ‘BBB’)

An example of the query 100C is shown below.

SELECT T2. C1 FROM T2 ORDER BY T2. C2

The query analysis unit 30 of the node 4B divides the query 100C into two processing phases. One processing phase is the data retrieval phase (the phase in which the data is retrieved from the database 8 existing in the storage 3B) corresponding to “SELECT T2. C1 FROM T2). The second processing phase is the data merge phase (for executing the sorting process for columns T2. C2) corresponding to “ORDER BY T2. C2”.

The process executed by the query analysis unit 30 to divide the query into the processing phases is explained above. This explanation based on the query 100C is only an example, and the divided processing phase is not limited to the data retrieval phase or the data merge phase. The query analysis unit 30 can handle various types of processing phases. For example, Joel L. Wold, John Turek, Ming-Syan Chen and Philip S. Yu: “A Hierarchical Approach to Parallel Multiquery Scheduling”, IEEE Transactions on Parallel and Distributed Systems, 6(6): 578-590, Jun. 1995” shows an example of dividing various queries into the processing phases. Also, the query analysis unit 30 may divide the query into the processing phases using the technique capable of processing the query at high speed as described in the aforementioned reference document.

The query analysis unit 30 determines by analysis that the data retrieval phase is the processing phase high (not low) in I/O load for accessing the storage 3B. Also, the query analysis unit 30 determines by analysis that the data merge phase is the processing phase high in CPU load accompanied by the sorting process.

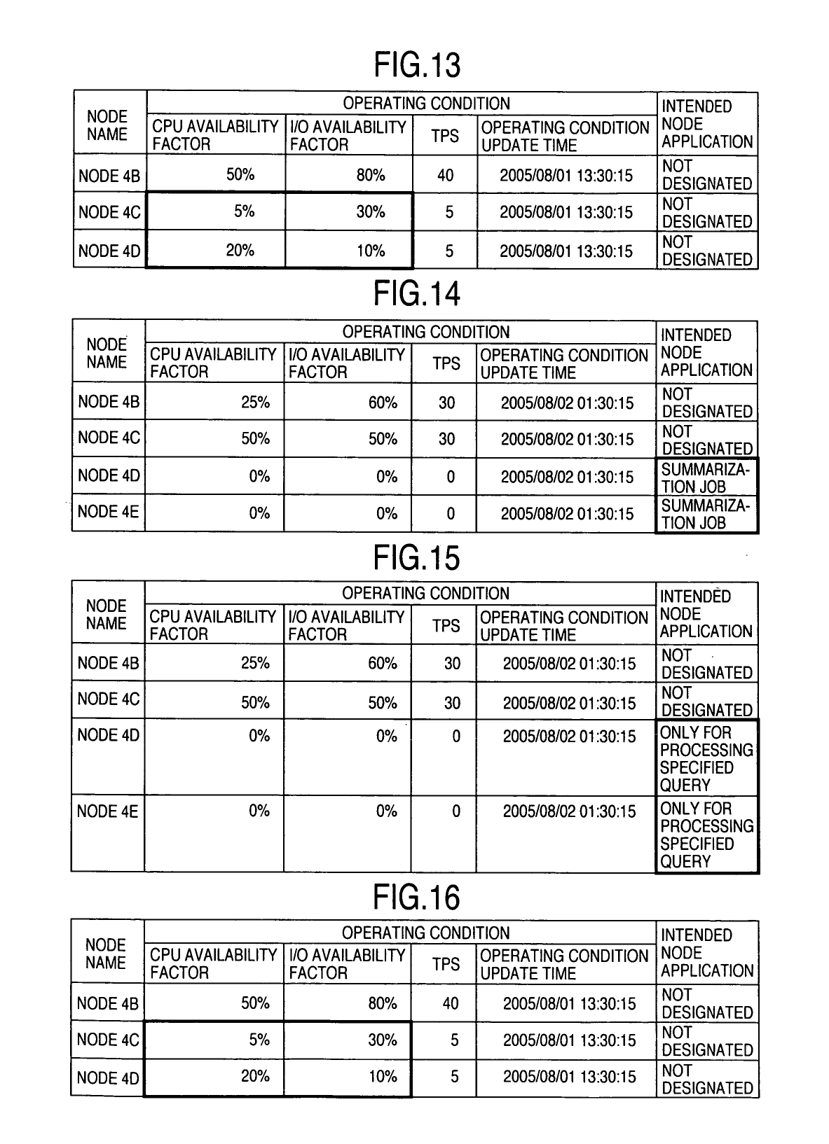

Next, the processing distribution unit 40 of the node 4B distributes the processing phases among the nodes. For this purpose, the node information management unit 70 acquires the node information and registers it in the node information management table 71 of the node 4B. The node 4B, which processes a great amount of the queries 10A, has a high CPU availability factor and a high I/O availability factor. The nodes 4C, 4D, which process the query 100B, on the other hand, is low in both CPU availability factor and I/O availability factor (FIG. 13).

The process distribution unit 40 of the node 4B distributes the data retrieval phase to the node 4C and the data merge phase to the node 4D in accordance with the process distribution flow shown in FIG. 8 using the node information input from the node information management unit 70. As a result, the query 100C is processed by the node 4C and the query execution unit 50 of the node 4C without being affected by the processing load of the queries 100A.

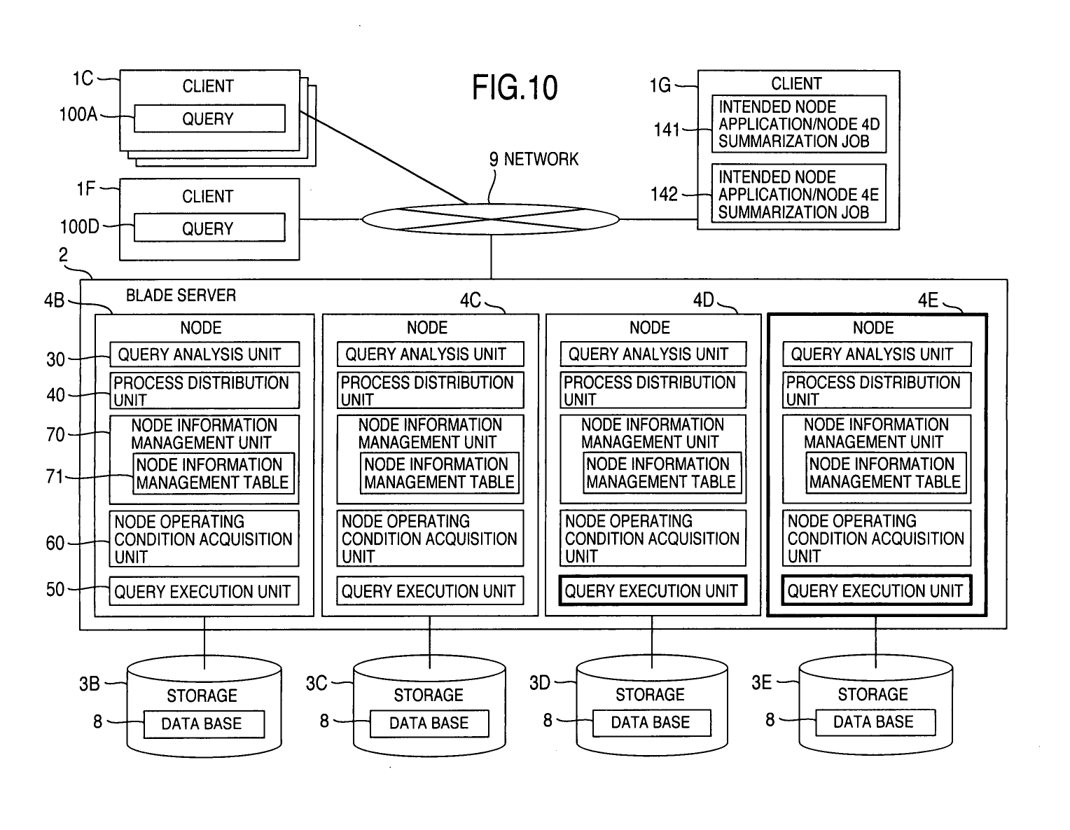

A second embodiment is explained below. FIG. 10 shows a system configuration in which the node 4E is added to the resources shown in the system configuration in FIG. 9. The node 4D is added to the system shown in FIG. 9 having an insufficient performance of executing the summarization process. As a result, the DBMS operates with four blades (nodes 4B, 4C, 4D, 4E) inserted into the blade server 2. In this way, by adding the node 4E appropriately to the blade server 2, the number of nodes can be increased or decreased as required to save the equipment cost.

The client 1G, in accordance with the flow of the registration of the intended application shown in FIG. 6, registers the “summarization job” as an intended node application 141 of the node 4D and an intended node application 142 of the node 4E in the node information management table 71 for all the nodes existing in the system. Now, the operation is explained in which the client 1C requests the query 100A for the on-line business from the DBMS.

The query analysis unit 30 of the node 4B determines the query application of the query 100A as an on-line business in accordance with the conditions shown in FIG. 5. The process distribution unit 40 of the node 4B distributes each processing phase of the query 100A to the node 4B or 4C in accordance with the process distribution flow shown in FIG. 8 using the node information (FIG. 14) input from the node information management unit 70. The process distribution unit 40 of the node 4B distributes each processing phase in such a manner that the processing performance of the summarization job is not affected by the processing load of the query 100A on the on-line business.

Next, the operation is explained in which the client 1F requests the query 100D of the summarization job from the DBMS. An example of the query 100D is shown below.

SELECT T3. C1

SUM (T3. C2) FROM T3 WHERE T3. C3>=‘2005-04-01’ GROUP BY T3. C1 ORDER BY 2

The query analysis unit 30 of the node 4B, according to the conditions shown in FIG. 5, determines the application of the query 100 as the summarization job. The process distribution unit 40 of the node 4B distributes each processing phase of the query 100D (summarization job) to the node 4D or 4E in accordance with the process distribution flow shown in FIG. 8 using the node information (FIG. 14) input from the node information management unit 70.

After that, each node to which the processing phase is distributed processes the query from the client 1G about the summarization job in accordance with the flow of the intended application registration shown in FIG. 6 without being affected by the processing load of the other transactions until “not designated” is registered as an intended application.

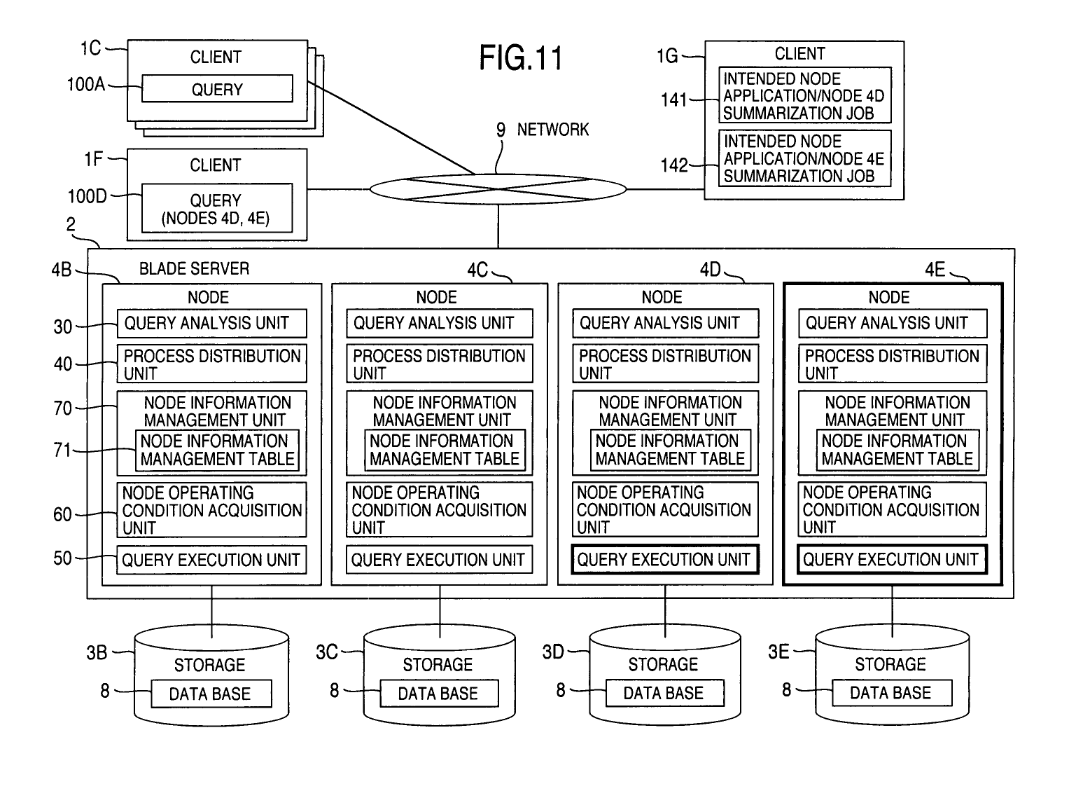

A third embodiment is explained below. The feature of the third embodiment lies in that each phase of the query process is distributed to the nodes designated by the user in advance. As a result, at the time of making a query, the effect of the processing load of the other transactions can be intentionally suppressed. FIG. 11 shows a system configuration in which the user requesting a query designates the node to process the query.

The query 100D is input from the user through the query request unit 10 (FIG. 2). In this query 100D, the nodes 4D, 4E are expressly designated by the user as nodes to process the query. The client 1F transmits the query 100D to the node 4B functioning as a receiving window.

The process distribution unit 40 of the node 4B distributes each processing phase of the query 100D to the expressly designated node 4C or 4D in accordance with the process distribution flow shown in FIG. 8 using the node information (FIG. 15) input from the node information management unit 70.

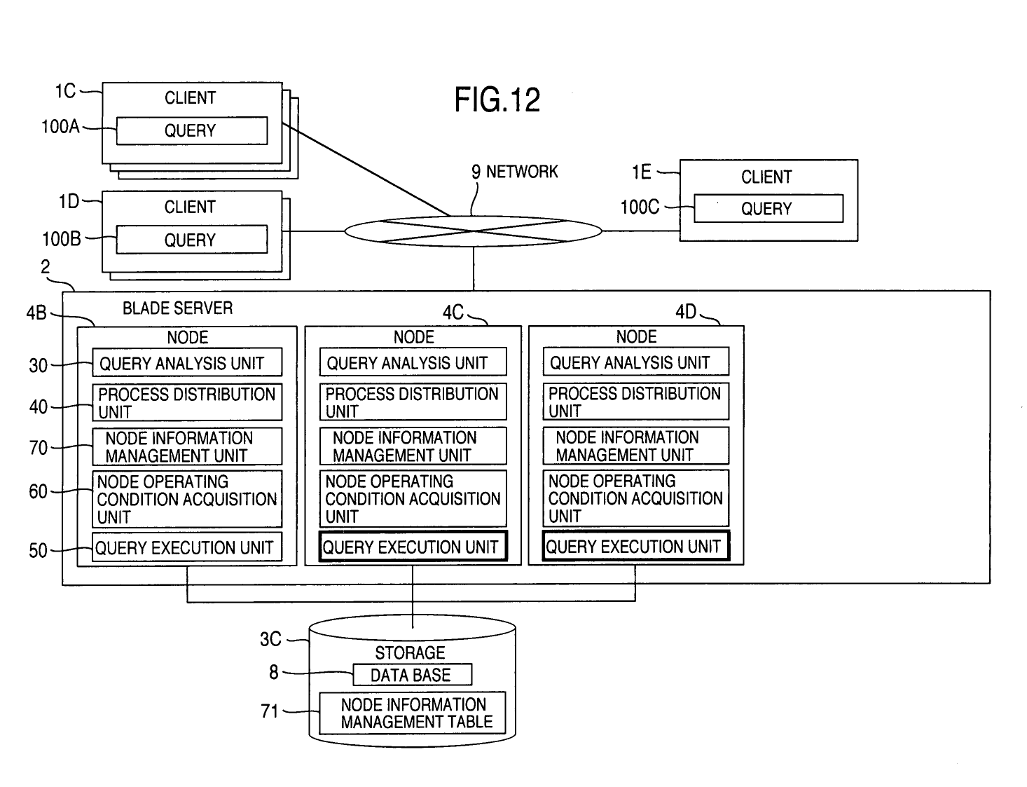

A fourth embodiment is described below. FIG. 12 shows a system configuration in which the first embodiment is applied to the RDBMS of the shared disk architecture. The DBMS operates with three blades (nodes 4B, 4C, 4D) inserted in the blade server 2. This configuration is different from the system configuration of shared disk architecture in that the storage 3C, the database 8 and the node information management table 71 are shared by a plurality of nodes. By the shared use of the DBMS storage 3C by the nodes makes possible the centralized management of the database 8 for a reduced management cost.

The process distribution unit 40 of the node 4B distributes each processing phase of the query 100C to the nodes. For this purpose, the node information management unit 70 acquires the node information and registers it in the node information management table 71 of the storage 3C. The node 4B processes a great amount of the queries 10A, and therefore has a high CPU availability factor and a high I/O availability factor, while the node 4C is low in CPU availability and I/O availability (FIG. 16).

The process distribution unit 40 of the node 4B distributes the data retrieval phase to the node 4C and the data merge phase to the node 4D in accordance with the process distribution flow shown in FIG. 8 using the node information input from the node information management unit 70. As a result, the query 100C is processed by the query execution unit 50 of the nodes 4C and 4D without being affected by the processing load of the queries 10A.

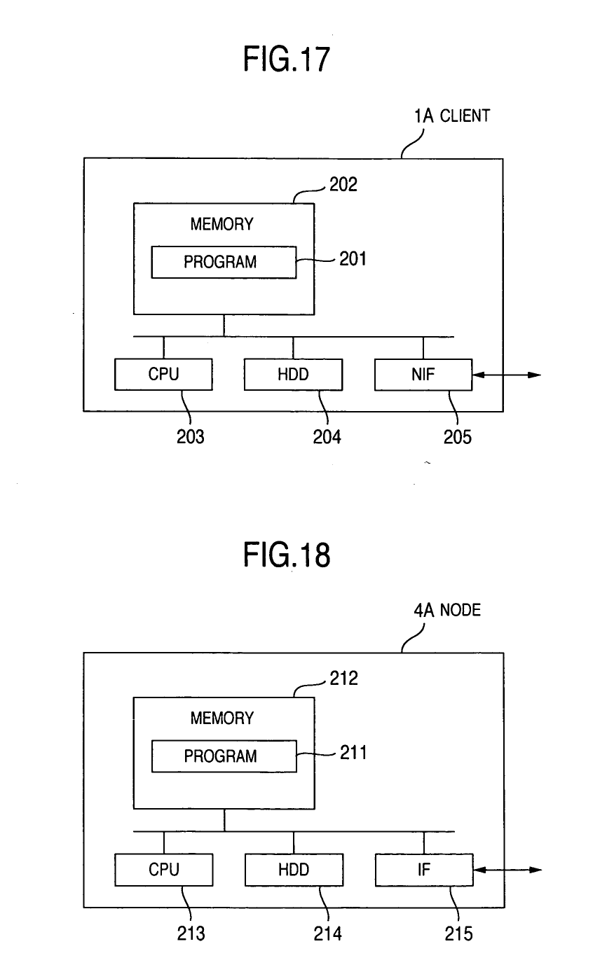

FIGS. 17, 18 show a hardware configuration of each device making up the data base system. In FIG. 17, the client 1A (like other clients) is a computer including a CPU (central processing unit) 203, a memory 202, a HDD (hard disk drive) 204 and a NIF (network interface) 205. The CPU 203 implements each component element described in FIG. 1 by executing the program 201 read into the memory 202.

In FIG. 18, the node 4A (like other nodes) is a computer including a CPU 213, a memory 212, a HDD 214 and an IF (interface) 215. The CPU 213 implements each component element shown in FIG. 1 by executing the program 211 read into the memory 212. Also, the IF 215 is an interface removable from the blade server 2 and acts as an intermediary for transmitting and receiving data to and from the blade server 2.

It should be further understood by those skilled in the art that although the foregoing description has been made on embodiments of the invention, the invention is not limited thereto and various changes and modifications may be made without departing from the spirit of the invention and the scope of the appended claims.

1. A database management method for instructing a plurality of nodes to execute queries to a data base stored in a storage, the method executed by a computer comprising:
receiving an input of a query;
dividing the input query into processing phases constituting units capable of being executed in parallel; and
distributing processing phases of the query among nodes based on a feature of the processing phases and an operating condition of each node at the time of execution of the processing phases.

2. The database management method according to claim 1,
wherein the processing phases are distributed in such a manner that a predetermined application for each node and an application of the query specified by a type of the query are compared with each other thereby to specify a node to which the processing phases are distributed.

3. The database management method according to claim 1,
wherein the processing phases are distributed in such a manner that by referring to a CPU availability factor of the nodes as the operating condition, a processing phase high in CPU load is distributed to a node low in I/O availability factor.

4. The database management method according to claim 1,
wherein the processing phases are distributed in such a manner that by referring to an I/O availability factor of the nodes as the operating condition, a processing phase high in I/O load is distributed to a node low in I/O availability factor.

5. The database management method according to claim 1,
wherein the processing phases are distributed in such a manner that a frequency at which the operating condition is updated is reduced for the nodes capable of processing a small number of transactions per unit time.

6. The database management method according to claim 1,
wherein the processing phases are distributed in such a manner that a frequency at which the operating condition is updated is reduced in the case where time elapsed from operating condition update time is short rather than long.

7. The database management method according to claim 1,
wherein the processing phases of the query are distributed preferentially to the nodes designated in the query.

8. The database management method according to claim 1,
wherein the plurality of nodes access the data base stored in one shared disk and execute the processing phases of the query.

9. A database management program for causing the computer to execute the database management method according to claim 1.

10. A database management program for causing the computer to execute the database management method according to claim 2.

11. A database management program for causing the computer to execute the database management method according to claim 3.

12. A database management program for causing the computer to execute the database management method according to claim 4.

13. A database management program for causing the computer to execute the database management method according to claim 5.

14. A database management program for causing the computer to execute the database management method according to claim 6.

15. A database management program for causing the computer to execute the database management method according to claim 7.

16. A database management program for causing the computer to execute the database management method according to claim 8.

17. A database management apparatus for instructing a plurality of nodes to execute queries to a data base stored in a storage, comprising:
a query request unit for receiving a query input;
a query analysis unit for dividing the input query into processing phases constituting units capable of being executed in parallel; and
a processing distribution unit for distributing processing phases of the query among the nodes based on a feature of each processing phase and an operating condition of each node at time of execution of the processing phase.

18. A database management system comprising the database management apparatus according to claim 17, nodes for executing the processing phases of queries, and a client device for receiving the processing result of the processing phases from the nodes and outputting the processing result about the request of the queries.

19. The database management system according to claim 18, wherein the plurality of nodes are accommodated in a blade server constituted of removable nodes.
